(19) United States
(12) Patent Application Publication
(10) Pub. No.: US 2016/0000097 A1
(43) Pub. Date: Jan. 7, 2016

(54) Enhanced Mold Resistant Products at Refrigerated Conditions and Methods of Forming Thereof

(71) Applicant: Kraft Foods Group Brands LLC, Northfield, IL (US)

(72) Inventors: Gary Francis Smith, Glenview, IL (US); Keith D. Forneck, Chicago, IL (US)

(21) Appl. No.: 14/321,993

(22) Filed: Jul. 2, 2014

(51) Int. Cl. A21D 15/02; A23C 19/10

(52) U.S. Cl. CPC A21D 15/02; A23C 19/10

(57) ABSTRACT

Methods of imparting resistance to mold to a food product during extended storage at refrigerated temperatures by topically applying a live yeast and fermented aqueous sugar and ethanol solution to a surface of the food product are provided. The live yeast and fermented aqueous sugar and ethanol solution contains about 1% to about 5% live yeast, about 5% to about 40% sugar, and about 5% to about 20% ethanol and is applied in an amount of about 0.5 to about 2 ml per about 80 to about 100 grams of food product. The live yeast converts ethanol into acetaldehyde at a rate which imparts mold resistance to the food product for up to 6 months at refrigerated temperatures.

### FIELD

The present disclosure relates to extending the refrigerated shelf-life of food products.

### BACKGROUND

The shelf-life of food products may be extended in a variety of ways depending on the type of food product and the factors that contribute to the length of the food product's shelf-life. The shelf-life of a food product may be limited due to microbial spoilage, mold, and loss of desirable organoleptic properties such as taste and texture due to time. Food product shelf-life may also be limited as a result of loss or absorption of moisture and degradation of the food product. Shelf-lives of food products may be extended, for example, through the use of preservatives, modifying packaging conditions, heat and/or pressurization treatments, irradiation, adjusting the pH of a food, and surface treatments to address the factors that may shorten a product's shelf-life. However, the degree of shelf-life extension with respect to mold inhibition of prior products and methods has previously been limited to about 3 months or less.

For example, bread products are normally available as freshly prepared products that are intended to be consumed within a relatively short time period or as frozen products which can be stored in the frozen state for relatively long periods of time. Such frozen bread products, once thawed, generally must also be consumed within a relatively short time period. Bread products are generally not sold as refrigerated products because once a fully baked bread product has been refrigerated, it tends to “toughen” or become leathery, stale, and/or dry.

In some cases, prior bread products that were not intended to be refrigerated typically had shelf-lives of around 7 to 11 days before mold spots appeared on the bread product. Surface treatment of bread, such as through the use of yeast or calcium propionate, may extend the shelf-life of unrefrigerated bread by up to around 20 to around 25 days.

In other cases, bread that was intended for refrigeration may include an enzyme to prepare the bread product to have improved resistance to staleness when stored under refrigerated conditions. In this prior approach, the shelf-life of bread may be extended by refrigeration. However, the expected shelf-life of refrigerated bread in such prior enzyme-treated approach was still typically around 2 months or less, and further extendable to about 3 months if modified atmosphere packaging (MAP) was used with the bread.

Solid dairy products, such as cheese, cheese shreds, etc., also have a limited shelf-life. Cheese is also one example of a food product which may benefit from a surface treatment to extend shelf-life. Certain cheeses, such as shredded cheddar cheese, when stored at ambient conditions have an expected shelf-life of about 8 days or less before mold spots appear on the shredded cheese. An extended shelf-life of the ambient stored cheese may be obtained with a surface treatment of yeast and alcohol applied to the shredded cheese, but this may only extend the shelf-life of the shredded cheese to approximately 19 days or less.

Thus, these prior approaches were able to extend the shelf-life of food products at ambient conditions to about 20 to about 25 days at the most, or by refrigeration to around 3 months. These approaches however, were unable to extend the refrigerated shelf-life of products by delaying the onset of undesirable organoleptic properties and/or mold for longer than 3 months even when modified atmosphere packaging (MAP) was used. Thus, the prior expectation of mold prevention methods, even in the context of refrigerated foods and with modified packaging, was that mold could be prevented for only up to 3 months.

### SUMMARY

A method of imparting resistance to mold and texture degradation to a baked product during extended storage at refrigerated temperatures is provided. A baked product with a starch-degrading bacterially derived amylase enzyme is prepared. A live yeast and fermented aqueous sugar and ethanol solution is applied to a surface of the baked product prepared with the starch-degrading bacterially derived amylase enzyme. In one approach, the live yeast and fermented aqueous sugar and ethanol solution contains about 1% to about 5% live yeast, about 5% to about 40% sugar, and about 5% to about 20% ethanol, and is applied to the surface of the baked product in an amount of about 0.5 to about 2 ml per about 80 to about 100 grams of baked product. The baked product is sealed in a package and refrigerated at a temperature of about 0° C. to about 10° C. The live yeast converts ethanol to acetaldehyde to provide a baked product that is free of mold for up to 6 months and beyond at refrigerated temperatures.

In another aspect, a refrigerated packaged baked product with resistance to mold and texture degradation during extended storage at refrigerated temperatures is provided. The refrigerated packaged baked product includes a baked product prepared with a starch-degrading bacterially derived amylase enzyme and a live yeast and fermented aqueous sugar and ethanol solution applied to a surface of the baked product. By one approach, the fermented live yeast and aqueous sugar and ethanol solution contains about 1% to about 5% live yeast, about 0 percent to about 40 percent sugar (in some cases, about 5% to about 40% sugar), and about 5% to about 20% ethanol. The live yeast and fermented aqueous sugar and ethanol solution may be applied in an amount of about 0.5 to about 2 ml per about 80 to about 100 grams of baked product. The refrigerated packaged baked product also includes a packaging within which the baked product is enclosed to provide an environment wherein the live yeast converts ethanol in the aqueous solution to acetaldehyde and the baked product is free of mold for up to 6 months when stored at refrigerated temperatures of about 0° C. to about 10° C.

In another aspect, a method of imparting resistance to mold in a cheese during extended storage at refrigerated temperatures by applying a live yeast and fermented aqueous sugar and ethanol solution to a surface of the cheese is provided. In one approach, the live yeast and fermented aqueous sugar and ethanol solution contains about 1% to about 5% live yeast, about 0% to about 40% sugar, and about 5% to about 20% ethanol. The live yeast and fermented aqueous sugar and ethanol solution may be applied in an amount of about 0.5 to about 2 ml per about 80 to about 100 grams of cheese. The cheese is sealed in a package and refrigerated at a temperature of about 0° C. to about 10° C. The live yeast converts ethanol to acetaldehyde to provide cheese that is free of mold for up to 6 months at refrigerated temperatures.

In yet another aspect, a refrigerated packaged cheese with extended storage at refrigerated temperatures is provided. The refrigerated packaged cheese includes cheese prepared by applying a live yeast and fermented aqueous sugar and ethanol solution to a surface of the cheese. By one approach, the live yeast and fermented aqueous sugar and ethanol solution contains about 1% to about 5% live yeast, about 0% to about 40% sugar, and about 5% to about 20% ethanol. The live yeast and fermented aqueous sugar and ethanol solution may be applied in an amount of about 0.5 to about 2 ml per about 80 to about 100 grams of cheese. The refrigerated packaged cheese also includes a packaging within which the cheese is enclosed to provide an environment wherein the live yeast converts ethanol in the aqueous solution to acetaldehyde and the cheese is free of mold for up to 6 months when stored at refrigerated temperatures of about 0° C. to about 10° C. and without imparting yeast flavors to the cheese.

As discussed in more detail below, the refrigerated shelf-life of food products such as cheese and baked goods are unexpectedly extended by the application of a live yeast and fermented aqueous sugar and ethanol solution which produces acetaldehyde to inhibit the growth of mold.

### DETAILED DESCRIPTION

Methods of imparting resistance to mold in food products, such as cheese and baked products, during extended storage for up to about 6 months at refrigerated temperatures, and refrigerated packaged food products, such as cheese and baked goods with extended shelf-life up to about 6 months and beyond are provided. In one aspect, the methods and products herein include the topical application of a live yeast and fermented aqueous sugar and ethanol solution to a surface of the food product for imparting mold resistance to the food product during the refrigerated shelf-life of the food product for at least about 6 months. The live yeast in the presence of oxygen at refrigerated temperatures converts ethanol in the topical application into acetaldehyde at a rate effective to impart mold resistance to the refrigerated packaged food product for a time period dramatically longer than previously achievable by prior methods to extend mold-resistant shelf-life. Once the live yeast and ethanol is applied to the food product and packaged, the conversion of ethanol into acetaldehyde by the live yeast acts as an acetaldehyde generating system within the packaged environment that continues until the ethanol is depleted. In another aspect, also provided are methods of imparting resistance to mold and texture degradation to baked products during extended storage at refrigerated temperatures by preparing a baked product with a starch-degrading bacterially derived amylase enzyme to which the live yeast and fermented aqueous sugar and ethanol solution is applied. The baked products herein also demonstrate resistance to mold for at least about 6 months at refrigerated conditions.

As consumers are increasingly aware of the composition of foods, it is advantageous to prepare food products with more natural ingredients. The use of a mold inhibitory compound comprising naturally occurring mold inhibitor volatiles allows for a food product that is perceived as more natural to be presented to the consumer. Acetaldehyde is one example of a naturally occurring volatile which has antifungal and antibacterial properties. Naturally occurring mold inhibitor volatiles may be used in lieu of antimicrobials and mold inhibitors such as natamycin, sorbic acid, calcium propionate and the like. Thus, the food products herein, in one approach are substantially free of such components (that is, natamycin, sorbic acid, calcium propionate and the like). By substantially free of, the food products herein includes less than 0.5%, in other cases, less than 0.1%, and in yet other cases, no amounts of such components.

The food product may be any food product suitable for refrigeration and packaging, and/or any food product that may be rendered suitable for refrigeration and packaging. In one approach, the refrigerated packaged food product is a cheese. The cheese may be formed in any size or shape, such as shredded cheese, or cheese sticks, slices, loaves, or bricks of cheese. The cheese may be a freshly made or aged natural cheese such as cheddar, gouda, mozzarella, provolone, and Swiss, or a processed cheese prepared from any natural cheese. By one approach, the cheese may be a shredded cheese such as shredded cheddar cheese. In other approaches, the cheese, such as shredded cheese, may contain an anti-caking agent. In some approaches, the refrigerated food product may be a baked product, such as cookies, bagels, buns, cakes, donuts, rolls, and loaves of bread. As used herein, refrigerated storage conditions may be between about 0° C. to about 10° C., such as about 3° C. to about 5° C.

The live yeast and fermented aqueous sugar and ethanol solution may be applied to food products herein to unexpectedly extend the refrigerated shelf-life of the products to about 4 months or longer, such as about 6 months or longer. The use of a live yeast and fermented aqueous sugar and ethanol solution on refrigerated packaged food products as described in the present disclosure unexpectedly far exceeds prior expectations of refrigerated shelf-life which was also only achievable using modified atmosphere packaging. The products and methods herein achieve mold inhibition to about 4 months or longer, such as about 6 months or greater under refrigerated conditions. As used here, mold inhibition means that no mold is visible, and that there is no mold taste or aroma.

Turning to more of the specifics, the present disclosure provides a method for imparting resistance to mold in a food product such as cheese or a baked product by topically applying a live yeast and fermented aqueous sugar and ethanol solution containing about 1% to about 5% live yeast, about 0% to about 40% sugar, and about 1% to about 30% ethanol, in an amount of about 0.5 to about 2 ml per about 80 to about 100 grams of food product to a surface of the food product. The food product with the topical application is inhibited from mold formation while stored under refrigerated conditions at about 0° C. to about 10° C. for at least 6 months.

By one approach, the live yeast is present in the topically applied solution in an amount of between about 0.1% to about 5%, such as about 0.5% to about 4.5%, or about 1% to about 3%. By other approaches, the live yeast is present in the aqueous solution in an amount of between about 1% to about 2.5%.

Any suitable yeast that is safe for human consumption may be used. In one approach, the yeast is one that remains viable for several weeks. In other approaches, the yeast remains viable for several months, such as at least 4 months, or at least 6 months. The yeast may be baker's yeast.

In one approach, the amount of sugar in the aqueous solution is between about 0% to about 40%, about 5% to about 40% sugar, such as about 10% to about 30%, or about 20%. Any suitable sugar may be used for the fermented aqueous solution of yeast, sugar and ethanol. In some approaches, the sugar may be sucrose.

The live yeast and fermented aqueous sugar and ethanol solution may be prepared by combining live yeast and sugar with water to form a live yeast and aqueous sugar solution. The live yeast and aqueous sugar solution is then fermented to provide a live yeast and fermented aqueous sugar and ethanol solution having a desired level of ethanol. By one approach, the live yeast and fermented aqueous sugar and ethanol solution may be incubated for about 10 hours to about 30 hours, such as about 24 hours, at fermentation temperatures of about 68° F. (20° C.) to about 104° F. (40° C.), such as about 86° F. (30° C.) to ferment the live yeast and aqueous sugar solution. In other approaches, a solution of live yeast and ethanol may be prepared without fermenting a live yeast and aqueous sugar solution. However, by fermenting an aqueous sugar and live yeast solution, the sugar in the aqueous solution remains available to the live yeast and extends the viability of the yeast.

The fermentation may be carried out under time and temperature conditions to achieve the desired level of ethanol in the live yeast and fermented aqueous sugar and ethanol solution. In some approaches, the fermentation is carried out until the level of ethanol present in the live yeast and fermented aqueous sugar and ethanol solution is between about 1% to about 30% ethanol, such as about 5% to about 25%. In yet other approaches, the live yeast and sugar solution may be fermented such that the fermented solution contains about 10% to about 20%, such as about 10% or about 15% ethanol.

Once fermented, the live yeast and fermented aqueous sugar and ethanol solution may be applied on a surface of the food product by any known method, such as by spraying, coating, brushing, or dipping the food product with the live yeast and fermented aqueous sugar and ethanol solution such that a surface of the food product is in contact with the live yeast and fermented aqueous sugar and ethanol solution. In some approaches, a surface which comes in contact with the food product may be treated or coated with the live yeast and fermented aqueous sugar and ethanol solution to impart by contact, the live yeast and fermented aqueous sugar and ethanol solution to the food product. In some approaches, the surface of the food product to which the live yeast and fermented aqueous sugar and ethanol solution is applied absorbs the solution. In other approaches, at least a portion of the solution remains on the surface. When at least a portion of the solution remains on the surface of the product, the product may have a moisture content such that the portion of the solution that remains on the surface of the food product does not contribute an additional moisture that is noticeable to the consumer.

In some approaches the live yeast and fermented aqueous sugar and ethanol solution is applied in amounts of about 0.5 to about 2 ml per about 80 to about 100 grams of food product, such as about 1 ml to about 1.5 ml per about 90 to about 100 grams of food product. By one approach, the live yeast and fermented aqueous sugar and ethanol solution is applied to the food in an amount of 1% by weight.

By one approach, the application of the live yeast and fermented aqueous sugar and ethanol solution may be applied uniformly to provide complete coverage of the food product surface. In other aspects, the application of the live yeast and fermented aqueous sugar and ethanol solution may be applied to at least a portion of the food product, such as a surface of the food product or at least a portion of the surface of the food product. In some approaches, the live yeast and fermented aqueous sugar and ethanol solution may also be applied to at least a portion of the packaging of the packaged food product (in addition to or in the alternative to the topical application on the food product), such as a portion of the packaging wall that comes in contact with the food product when the food product is placed within the packaging.

The live yeast converts the ethanol into volatile acetaldehydes which is released into the packaging surrounding the food product. As a result, complete coverage of the food product surface is not necessarily required for mold resistance to be imparted to the entire packaged food product. The sugar present in the live yeast and fermented aqueous sugar solutions in some approaches may allow the yeast to multiply, thus extending the availability of live yeast to convert ethanol into volatile acetaldehyde. The live yeast in the presence of oxygen converts the ethanol into acetaldehyde which is trapped within the products' packaging environment to maintain a mold resistant packaged environment. Therefore, it is possible to apply the live yeast and fermented aqueous sugar and ethanol solution to a food product before or after further processing steps such as slicing bread, or slicing and shredding cheese, for example.

The live yeast and fermented aqueous sugar and ethanol solution may be sprayed onto a food product having a temperature suitable to maintain the viability of the live yeast. When applied to freshly baked goods, the live yeast and fermented aqueous sugar and ethanol solution is applied once the baked goods have sufficiently cooled to a temperature which allows viability of the live yeast.

In some approaches, the live yeast and fermented aqueous sugar and ethanol solution may be applied to a surface of the food product before the product is placed in a package. In other approaches, the live yeast and fermented aqueous sugar and ethanol solution is applied to at least a portion of the product after the product is packaged, such as a portion of the product that is accessible prior to sealing the package. In yet another approach, the live yeast and fermented aqueous sugar and ethanol solution may be applied to the inside of the product packaging. In another approach, the live yeast and fermented aqueous sugar and ethanol solution may be a separate component that is included with the packaging. A separate component, such as a pouch with live yeast and fermented sugar and ethanol solution may be included with the food component in its packaging so as to impart mold resistance to the food product.

Because the live yeast converts the ethanol into the acetaldehyde in the presence of oxygen, the level of acetaldehyde maintained in the packaged environment is affected by several factors, including the permeability of the packaging material to oxygen and/or acetaldehyde, and the level of oxygen available to the live yeast in the packaged environment for the conversion of ethanol into acetaldehyde. In some approaches, the level of oxygen in the packaged environment is replenished each time the package is opened to access the food product within. In other approaches, the packaging is oxygen permeable so as to provide a continuous source of oxygen to the packaged environment.

The packaging material may comprise a bag or a container, such as a recloseable or resealable bag or container. The packaging material is selected from any suitable material, such as polyethylene, or low density polyethylene which maintains the presence of acetaldehyde in the closed packaged environment to impart mold resistance to the food product. In some approaches, the food item is hermetically sealed in the packaging. Depending on the desired acetaldehyde level in the packaged food product, the packaging may be one that is permeable to one or both of oxygen and/or acetaldehyde. In other approaches, the packaging may be one that is impermeable to one or both of acetaldehyde or oxygen. The acetaldehyde continues to be generated by the live yeast in the presence of oxygen until the supply of ethanol is depleted.

The rate of conversion of ethanol into acetaldehyde under refrigerated conditions allows the acetaldehyde to be produced at a rate that imparts extended mold resistance to the food product. The refrigerated shelf life of cheese treated with a live yeast and fermented aqueous sugar and ethanol solution is unexpectedly extended to at least about 4 months without the need for MAP packaging. Likewise, the refrigerated shelf-life of a baked product, such as bread, treated with a live yeast and fermented aqueous sugar and ethanol solution is unexpectedly extended to at least about 6 months. The methods of the present disclosure thus provide a dramatically longer refrigerated shelf-life than previously achievable at refrigerated temperatures, and without the need to use the MAP packaging used in prior approaches. The methods of the present disclosure thus provide extended shelf-life without the need for costly MAP packaging process.

In another aspect, a method of imparting resistance to mold and texture degradation of a baked product during extended storage at refrigerated temperatures is provided by the present disclosure. Baked products are generally not sold as refrigerated products, and are normally available as freshly prepared products that are intended to be consumed within a relatively short time period. However, once a fully baked bread product has been refrigerated, it tends to “toughen” or become leathery, stale, and/or dry.

One feature of baked products is that refrigeration under non-freezing conditions can promote staleness, and undesirable flavors, odors, and coloration. When a baked component such as bread or a roll is held under refrigerated conditions for several days or more, it tends to undergo starch retrogradation and stale out, typically toughening or becoming leathery or dry and developing off odors and flavors. Retrogradation of starch occurs more rapidly under refrigerated conditions, and the starch crystallizes into irreversible crystal form. A product that is much too firm and even gritty is a typical characteristic of dough which has undergone such retrogradation. Chewing then becomes more difficult, and the baked product loses some of its chewability such that it no longer resembles freshly baked bread. Generally speaking, refrigeration at non-freezing temperatures negatively impacts the taste of a baked grain or flour product, such as baked breads or rolls. While freezing baked dough products for reasonable lengths of time actually maintains adequate freshness, refrigeration (from about 0° C. to about 10° C.) at above-freezing temperatures of typical baked grain or dough products or breads or rolls is detrimental to the desired moisture, flavor, aroma, firmness and texture of that product.

In some approaches, to render a baked product more suitable for refrigeration by delaying texture degradation as a result of starch retrogradation under refrigerated conditions, a starch-degrading, bacterially derived amylase enzyme may be used to prepare a baked product with improved resistance to texture degradation when stored under refrigerated conditions. In other approaches, the baked product with the starch-degrading, bacterially derived amylase enzyme may be used in combination with the topical application of the live yeast solution mentioned previously. When used, the amylase enzyme breaks down the starch in the bread during proofing and baking so that even after the bread has staled or polymerized in the refrigerator, for example, the starch is already broken down into finite pieces which feel in the mouth like fresh bread. In one approach, the live yeast and fermented aqueous sugar and ethanol solution used with the amylase enzyme may also be topically applied (such as after baking) to the baked product prepared with the starch-degrading enzyme to impart resistance to both mold and texture degradation during extended storage at refrigerated temperatures of about 0° C. to about 10° C. The combination of the surface treatment of a live yeast and fermented aqueous sugar and ethanol solution to a baked product, and the use of a starch-degrading amylase enzyme in the dough formulation unexpectedly results in baked products that are resistant to both mold and texture degradation much longer than previously achievable, such as at least about 6 months.

In some approaches, the starch-degrading enzyme is an exoamylase, such as an α-amylase derived from various Bacillus strains. The starch-degrading enzyme may be a maltogenic enzyme which is resistant to inactivation by heat up to a temperature of at least about 82° C. One such enzyme is identified by the trademark NOVAMYL, a recombinant maltogenic amylase having an exemplified activity of about 1500 MANU/g. The starch degrading enzymes hydrolyze the non-reducing terminal chain lengths of starches and other polysaccharides by cleaving mono- and oligosaccharide units at the (1-4) α-glucosidic linkages.

In another approach, a bread flavor additive may be used in the preparation of bread dough to maintain a bread flavor in the product during extended storage. In other approaches, the use of the live yeast and fermented aqueous sugar and ethanol solution provides a desirable yeast flavor for the duration of the baked product's refrigerated shelf-life such that a bread flavor additive is not needed.

In another aspect, the present disclosure provides a refrigerated packaged cheese with extended storage at refrigerated temperatures. In some approaches, the refrigerated packaged cheese is prepared by applying a live yeast and fermented aqueous sugar and ethanol solution to a surface of the cheese. In other approaches, the cheese treated with the live yeast and fermented aqueous sugar and ethanol solution may be packaged with a baked product such as bread. By one approach, the live yeast and fermented aqueous sugar and ethanol solution topically applied to cheese contains about 1% to about 5% live yeast, about 5% to about 40% sugar, and about 5% to about 20% ethanol. The live yeast and fermented aqueous sugar and ethanol solution may be topically applied to cheese in an amount of about 0.5 to about 2 ml per about 80 to about 100 grams of the cheese. The refrigerated packaged cheese includes a packaging within which the cheese is enclosed to provide an environment wherein the live yeast converts the ethanol in the solution to acetaldehyde, and the cheese is free of mold for up to 6 months when stored at refrigerated temperatures of about 0° C. to about 10° C.

In yet another aspect, a refrigerated packaged baked product with resistance to mold and texture degradation during extended storage at refrigerated temperatures is provided. The refrigerated packaged baked product includes a baked product prepared with a starch-degrading bacterially derived amylase enzyme and topical application of a live yeast and fermented aqueous sugar and ethanol solution applied to a surface of the baked product. By one approach, the topical application of live yeast and fermented aqueous sugar and ethanol solution applied on the baked product contains about 1% to about 5% live yeast, about 5% to about 40% sugar, and about 5% to about 20% ethanol. The live yeast and fermented aqueous sugar and ethanol solution may be applied in an amount of about 0.5 to about 2 ml per about 80 to about 100 grams of baked product. The refrigerated packaged baked product also includes a packaging within which the baked product is enclosed to provide an environment wherein the live yeast converts ethanol in the solution to acetaldehyde, and the baked product is free of mold for up to 6 months when stored at refrigerated temperatures of about 0° C. to about 10° C. By combining the use of the amylase enzyme to extend the shelf-life due to texture degradation and staling, and the use of a fermented live yeast and aqueous sugar and ethanol solution at refrigerated temperatures to extend the mold-resistant shelf-life, a baked product maintains its desirable organoleptic properties for the duration of its mold-resistant shelf-life.

The application of a live yeast and fermented aqueous sugar and ethanol solution to a surface of a baked product prepared using an internally contained starch-degrading amylase enzyme provides a strong, pleasant, yeasty fresh bread note to the baked product, even after at least about 6 months of refrigerated storage. The preparation of a baked product using only a starch-degrading amylase enzyme and without the application of a live yeast and fermented aqueous sugar and ethanol solution results in musty flavor notes during the shelf-life of the baked product. Thus, the use of the live yeast and fermented aqueous sugar and ethanol solution enables the baked product to have a much longer commercially viable shelf life.

Under refrigeration temperatures, the acetaldehyde is generated at a rate to impart mold resistance to a food product for up to at least 6 months. While not wishing to be limited by theory, the rate of acetaldehyde generation at refrigerated temperature is lower than the rate of acetaldehyde generation at room temperatures, where mold resistance could only be imparted to the food product for up to about 20 to 30 days for a bread product, and about 19 days for a shredded cheese without modified atmospheric packaging. The acetaldehyde generation is surprising favored related to the rate of mold growth even at refrigeration conditions where the rate of acetaldehyde production is slower than at ambient conditions. Surprising, the yeast in the solutions herein are still effective to produce sufficient levels of acetaldehyde throughout the shelf life of the products herein at refrigeration conditions.

The refrigerated packaged food products of the present disclosure may be packaged individually, or with one or more components which may or may not be similarly treated by an application of a live yeast and fermented aqueous sugar and ethanol solution. In some approaches, the live yeast and fermented aqueous sugar and ethanol treated component may be packaged with an untreated component to impart mold resistance to the untreated component. The placement of an untreated component in proximity to a treated product within an enclosed packaging environment allows acetaldehyde generated by the treated component to be shared with the untreated component to impart mold resistance to the untreated component. Such an arrangement allows beneficial packaging configurations of food products which increase efficiency and lower costs.

By one approach, a baked product component such as bread, and a cheese component may be packaged together with either or both of the bread and cheese having been treated with the live yeast and fermented aqueous sugar and ethanol solution. If the cheese and bread have the same moisture levels, they can be packaged in the same package. If the cheese and bread have different moisture levels, a barrier film can be used to prevent moisture migration from one component to another while allowing acetaldehyde to flow freely from one component to the other. This arrangement is beneficial, for example, where only the bread component in a package having both a bread component and cheese component is treated with the live yeast and fermented aqueous sugar and ethanol solution so as not to impart undesirable yeast flavor to the cheese component, yet the cheese component may still benefit from the acetaldehyde generated by the treated bread component.

In other approaches, a baked product containing a starch degrading amylase enzyme may be packaged with a cheese product where one or both components are subjected to a live yeast and fermented aqueous sugar and ethanol solution. The use of the amylase enzyme renders the baked product suitable for refrigeration by preventing staling of the baked component under the refrigeration conditions that allow yeast to convert ethanol to acetaldehyde at rates which impart extended mold-resistance. Thus the shelf-life of the baked product, by using an amylase enzyme, is brought closer to the shelf-life of the cheese product, and allows a baked product and a cheese product packaged together to have a much longer shelf-life than previous packaged combinations of a baked product and a cheese product, wherein the shelf-life may be limited by the shelf-life of one of the components, such as due to texture degradation of the baked component.

A better understanding of the present embodiment and its many advantages may be clarified with the following examples. The following examples are illustrative and not limiting thereof in either scope or spirit. Those skilled in the art will readily understand that variations of the components, methods, steps, and devices described in these examples can be used. Unless noted otherwise, all percentages and parts noted in this disclosure are by weight.

### EXAMPLES

### Example 1

Samples of shredded mild cheddar cheese without any added components (Control Sample 1), cheese with natamycin only (Control Sample 2) were compared with inventive samples of the same shredded mild cheddar cheese treated with an incubated sugar and yeast solution (with and without natamycin) under various storage conditions for a duration of 4 months. The samples were stored under ambient (70° F.) and refrigerated temperatures (42° F.), with and without MAP at oxygen levels of 2%.

Samples 2 and 4 (Table 1) of shredded mild cheddar cheese containing natamycin were prepared by combining about 163 g of a starch anticaking agent containing 300 ppm natamycin with 5287 g mild shredded cheese to prepare a shredded cheese sample with about 3% anticaking agent, and about 12 ppm natamycin.

Samples treated with incubated live yeast and sugar solution were prepared by applying 1 mL per 100 gram of shredded cheese of an incubated sugar and live yeast solution, without an anticaking agent. The incubated sugar and live yeast solution was prepared by incubating a 2.5% yeast and 20% sucrose solution for 24 hours at 30° C. to ferment the sugar and live yeast solution. The fermented 2.5% live yeast solution contained about 10% ethanol. After incubating and fermenting, the solution was applied to the surface of the cheese by spraying and agitating the cheese to distribute the live yeast solution onto the surface of the cheese.

Samples treated with natamycin and the incubated live yeast and sugar solution applied the individual treatments in combination.

Results of each of the samples are shown in Table 1 below.

TABLE 1

| | | Storage Conditions | | | |
|---|---|---|---|---|---|
| | | | | MAP | |
| | | Non-MAP | | (2% Residual O2) | |
| | | Ambient | Refrig- | Ambient | Refrig- |
| Cheese Samples | | Temp | erated | Temp | erated |
| 1 | Control Cheese | Oiling off at | Mold at | No Mold | No Mold |
| | | about 1 week | 4 weeks | Growth | Growth |
| 2 | Cheese with | Oiling off at | Mold at | No Mold | No Mold |
| | Natamycin | about 1 week | 4 weeks | Growth | Growth |
| 3 | Cheese with | Oiling off at | 4 months | No Mold | No Mold |
| | Yeast and | about 1 week | without | Growth | Growth |
| | Sugar Solution | | mold | | |
| 4 | Cheese with | Oiling off at | 4 months | No Mold | No Mold |
| | Natamycin and | about 1 week | without | Growth | Growth |
| | Yeast and | | mold | | |
| | Sugar Solution | | | | |

The samples under the various storage conditions were visually inspected over 4 months. Results after 4 months show that refrigerated, non-MAP shredded cheddar cheese samples treated with the yeast and sugar solution (Inventive Samples 3 and 4) performed better than the control cheese sample without natamycin (Control Sample 1), and the control cheese sample with natamycin only and without the 1% live yeast and sugar solution (Control Sample 2) under the same storage conditions.

The samples prepared with the 1% incubated yeast and sugar solution appeared to have slight fermentation aromatics and profile upon consuming. Samples prepared with anticaking agent left a starchy coating on the tongue that hindered melt and mouth feel of cheese.

Within one week, all ambient samples were oiling off and appeared to be melting together. No mold growth was observed on the ambient temperature samples stored under non-MAP conditions likely due to the presence of the oil on the surface of the cheese interfering with mold growth. No mold growth was observed for cheese samples stored under MAP (2% O₂) conditions at both refrigerated and ambient temperatures likely due to the low oxygen levels in the modified atmosphere packaging being inhibitory to mold growth. Samples without MAP appeared lighter in color when compared with samples packaged using MAP, for both ambient and refrigerated storage conditions.

### Example 2

Bread samples without a treatment for imparting mold resistance were compared with bread samples treated with either calcium propionate incorporated in the bread formulations, or a fermented live yeast solution applied to the bread surface for 24 weeks under ambient or refrigerated storage conditions. All bread samples were prepared with a bacterially-derived starch degrading enzyme. All bread samples were prepared using the same dough formulation, with the exception of Sample 1 which further incorporated calcium propionate and a bread flavor additive.

Bread Sample 1 included 3% of calcium propionate. Bread Sample 2 was surface treated with a 2.5% live yeast solution (fermented 2.5% live yeast and 20% sucrose) at about 0.9 grams per 90 gram of bread. Control Bread Sample was not surface treated with either the calcium propionate or the live yeast solution. Half of each of the bread samples was placed in a ZIPLOCK storage bag for storage at ambient conditions (70° F.), and half of each of the bread samples was placed in a ZIPLOCK storage bag for storage at refrigerated conditions (42° F.) for comparison over 24 weeks.

Results are shown in Table 2 below.

TABLE 2

| | Storage Conditions | |
|---|---|---|
| Bread Samples | Ambient | Refrigerated |
| Sample 1 - with Calcium | No mold at 24 weeks but | No mold at 24 weeks but strong |
| Propionate | slight musty notes at | musty notes starting at week 8, |
| | 6 weeks | unpalatable by 24 weeks |
| Sample 2 - Surface | Moldy at week 11, but | No mold at 24 weeks, good flavor |
| Treatment with 1% Yeast | maintains fresh fermented | at 24 weeks with fresh fermented |
| | notes up to at least | notes |
| | 11 weeks | |
| Sample 3 - No Surface | Moldy at day 10 | Moldy at 8 weeks with stale |
| Treatment (Control) | | musty notes starting at day 21 |
| | | (3 weeks) |

Sample 1 which contained calcium propionate was mold resistant for up to at least 24 weeks, but had slight musty notes beginning at week 6 for the ambient sample, and strong musty notes beginning at week 8 for the refrigerated sample.

Sample 2 which was surface treated with fermented live yeast solution and stored at ambient conditions became moldy at week 11 but maintained fresh fermented notes up to week 11. Sample 2 that was stored at refrigerated conditions remained mold-free for up to 24 weeks, and maintained fresh yeast fermentation notes up to 24 weeks. Upon tasting after 12 weeks, refrigerated storage samples with the live yeast solution had eating qualities and yeasty fermentation notes associated with freshly baked bread. This continued through week 24, with the sample still imparting a strong, pleasant yeast bread aroma and flavor to the refrigerated sample, but with slight refrigerated notes, likely due to the use of a ZIPLOCK bag to seal the samples.

Sample 3 which did not include either calcium propionate or a fermented live yeast solution was moldy at day 10 when stored under ambient conditions, and was moldy at 8 weeks when stored under refrigerated conditions. Sample 3 had stale, musty notes starting at day 21 (3 weeks) under refrigerated conditions.

Thus, Sample 2 with a surface treatment of a fermented live yeast solution is able to maintain both mold resistance and fresh yeast fermentation notes for up to at least 24 weeks, greatly extending shelf-life beyond what was previously achievable. It is believed that both mold resistance and fresh yeast fermentation notes will easily extend beyond the 24 weeks used for evaluation in this example.

It will be understood that various changes in the details, materials, and arrangements of formulations and ingredients, which have been herein described and illustrated in order to explain the nature of the method and compositions, may be made by those skilled in the art within the principle and scope of the description and claims herein.

1. A method of imparting resistance to mold and texture degradation to a baked product during extended storage at refrigerated temperatures, the method comprising the steps of:
preparing a baked product with a starch-degrading bacterially derived amylase enzyme;
applying a live yeast and fermented aqueous sugar and ethanol solution containing about 1% to about 5% live yeast, about 0% to about 40% sugar, and about 5% to about 20% ethanol in an amount of about 0.5 to about 2 ml per about 80 to about 100 grams of baked product to a surface of the baked product;
sealing the baked product in a package;
refrigerating the packaged baked product at a temperature of about 0° C. to 10° C.; and
wherein the live yeast and fermented aqueous sugar and ethanol solution produces acetaldehyde and the baked product is free of mold for up to 6 months when stored at refrigerated temperatures of about 0° C. to about 10° C.

2. The method of claim 1 wherein the live yeast and fermented aqueous sugar and ethanol solution contains about 2% to about 3% live yeast, about 10% to about 30% sugar, and about 8% to about 15% ethanol.

3. The method of claim 2 wherein the live yeast and fermented aqueous sugar and ethanol solution contains about 2.5% live yeast, about 20% sugar, and about 10% ethanol.

4. The method of claim 1 wherein the live yeast and fermented aqueous sugar and ethanol solution is applied in an amount of about 1 ml to about 1.5 ml per about 90 to about 100 grams of baked product.

5. The method of claim 1 wherein the sugar is sucrose.

6. The method of claim 1 wherein the baked product is hermetically sealed in the package.

7. A refrigerated packaged baked product prepared by applying a live yeast treatment to a surface of the baked product comprising:
a baked product prepared with a starch-degrading bacterially derived amylase enzyme and with a live yeast and fermented aqueous sugar and ethanol solution containing about 1% to about 5% live yeast, about 0% to about 40% sugar, and about 5% to about 20% ethanol from the fermentation, applied on a surface of the baked product in an amount of about 0.5 to about 2 ml per about 80 to about 100 grams of baked product;
a packaging within which the baked product is enclosed; and
wherein the live yeast and fermented aqueous sugar and ethanol solution produces acetaldehyde and the baked product is free of mold for up to 6 months when stored at refrigerated temperatures of about 0° C. to about 10° C.

8. The refrigerated packaged baked product of claim 7 wherein the live yeast and fermented aqueous sugar and ethanol solution includes about 2% to about 3% live yeast, about 10% to about 30% sugar, and about 8% to about 15% ethanol.

9. The refrigerated packaged baked product of claim 8 wherein the live yeast and fermented aqueous sugar and ethanol solution includes about 2.5% live yeast, about 20% sugar, and about 10% ethanol.

10. The refrigerated packaged baked product of claim 7 wherein the live yeast and fermented aqueous sugar and ethanol solution is applied in an amount of about 1 ml to about 1.5 ml per about 90 to about 100 grams of baked product.

11. The refrigerated packaged baked product of claim 7 wherein the sugar is sucrose.

12. The refrigerated packaged baked product of claim 7 wherein the baked product is hermetically sealed in the packaging.

13. A method of imparting resistance to mold in a cheese during extended storage at refrigerated temperatures, the method comprising the steps of:
applying a live yeast and fermented aqueous sugar and ethanol solution containing about 1% to about 5% live yeast, about 0% to about 40% sugar, and about 5% to about 20% ethanol, in an amount of about 0.5 to about 2 ml per about 80 to about 100 grams of cheese to a surface of the cheese;
sealing the cheese in a package;
refrigerating the packaged cheese at a temperature of about 0° C. to about 10° C.; and
wherein the live yeast and fermented aqueous sugar and ethanol solution produces acetaldehyde and the cheese is free of mold for up to 6 months when stored at refrigerated temperatures of about 0° C. to about 10° C. without imparting yeast flavors to the cheese.

14. The method of claim 13 wherein a live yeast and fermented aqueous sugar and ethanol solution contains about 2% to about 3% live yeast, about 10% to about 30% sugar, and about 8% to about 15% ethanol.

15. The method of claim 14 wherein the live yeast and fermented aqueous sugar and ethanol solution contains about 2.5% live yeast, about 20% sugar, and about 10% ethanol.

16. The method of claim 13 wherein a live yeast and fermented aqueous sugar and ethanol solution is applied in an amount of about 1 ml to about 1.5 ml per about 90 to about 100 grams of cheese.

17. The method of claim 13 wherein the sugar is sucrose.

18. The method of claim 13 wherein the cheese is hermetically sealed in the package.

19. A refrigerated packaged cheese prepared by applying a live yeast treatment to a surface of the food product comprising:
a cheese with a live yeast and fermented aqueous sugar and ethanol solution containing about 1% to about 5% live yeast, about 0% to about 40% sugar, and about 5% to about 20% ethanol applied to a surface of the cheese in an amount of about 0.5 to 2 ml per about 80 to about 100 grams of cheese;
a packaging within which the cheese is enclosed; and
wherein the live yeast and fermented aqueous sugar and ethanol solution produces acetaldehyde and the cheese is free of mold for up to 6 months when stored at refrigerated temperatures of about 0° C. to about 10° C. without imparting yeast flavors to the cheese.

20. The refrigerated packaged cheese of claim 19 wherein the live yeast and fermented aqueous sugar and ethanol solution includes about 2% to about 3% live yeast, about 10% to about 30% sugar, and about 8% to about 15% ethanol.

21. The refrigerated packaged cheese of claim 20 wherein the live yeast and fermented aqueous sugar and ethanol solution includes about 2.5% live yeast, about 20% sugar, and about 10% ethanol.

22. The refrigerated packaged cheese of claim 19 wherein the live yeast and fermented aqueous sugar and ethanol solution is applied in an amount of about 1 ml to about 1.5 ml per about 90 to about 100 grams of cheese.

23. The refrigerated packaged cheese of claim 19 wherein the sugar is sucrose.

24. The refrigerated packaged cheese of claim 19 wherein the cheese is hermetically sealed in the packaging.
